(19) United States
(12) Patent Application Publication
(10) Pub. No.: US 2014/0075964 A1
(43) Pub. Date: Mar. 20, 2014

(54) PUMPING AND VAPORIZATION SYSTEM FOR ENHANCED OIL RECOVERY APPLICATIONS

(71) Applicants: Joseph Naumovitz, Lebanon, NJ (US); Andreas Opfermann, Munich (DE)

(72) Inventors: Joseph Naumovitz, Lebanon, NJ (US); Andreas Opfermann, Munich (DE)

(21) Appl. No.: 13/753,634

(22) Filed: Jan. 30, 2013

Related U.S. Application Data
(60) Provisional application No. 61/702,310, filed on Sep. 18, 2012.

(51) Int. Cl. F17C 9/02

(52) U.S. Cl. CPC F17C 9/02
USPC 62/50.2

(57) ABSTRACT

A cryogenic liquid such as liquid nitrogen or liquid carbon dioxide is pumped via a high pressure pump to a vaporizer where the liquid becomes gas. The higher pressure gas is cooled by a coolant exchanger and can be fed to an onsite unit operation such as an enhanced oil recovery operation. The coolant exchanger is in a thermal exchange relationship with a combustion engine which powers a hydraulic pump which feed hydraulic fluid to drive the high pressure pump.

### CROSS REFERENCE TO RELATED APPLICATIONS

The present application claims priority from U.S. provisional application Ser. No. 61/702,310 filed Sep. 18, 2012.

### BACKGROUND OF THE INVENTION

The development of enhanced oil recovery projects is complex requiring the methodology to be tailored to each specific oil reservoir. To improve the success of these projects it is often necessary to conduct pilot injection tests to measure well injectivity, areal sweep and conformance, gravity override, viscous fingering, and loss of mobility control. The conditions of the oil reservoir will help to determine whether carbon dioxide or nitrogen is the appropriate fluid for enhanced oil recovery (EOR).

The carbon dioxide or nitrogen that is necessary for EOR must be supplied at higher pressures and requires pumping and vaporization systems. Typically these pumping and vaporization systems are separate systems such that one system provides high pressure carbon dioxide and a second system provides high pressure nitrogen. However, much of the required usage for these gases is for less than one year and each type of system requires significant capital investment.

The present invention is able to overcome this limitation by using a system that can pump and vaporize either liquid nitrogen or liquid carbon dioxide to their gaseous state to a location where an operator has need for either of these gases such as for enhanced oil recovery operations.

### SUMMARY OF THE INVENTION

The invention provides for a system for providing a gas selected from the group consisting of nitrogen and carbon dioxide for use in enhanced oil recovery operations comprising a source of said gas and a storage vessel for said gas, utilizing an interchangeable pump, and a single (non-interchangeable) vaporizer system capable providing either gas at a specified delivery pressure and temperature.

The invention operates to provide a high pressure gas to an end user for use in enhanced oil recovery operations. The invention starts with liquid carbon dioxide and/or nitrogen, using a pump set to increase the supply pressure and direct the liquid to an air fan vaporizer. The liquid carbon dioxide or nitrogen is typically drawn from a storage tank by the pump. The carbon dioxide and/or nitrogen air vaporizer will vaporize the liquid and will provide higher pressure gas to the location where the end user can employ the higher pressure gas in enhanced oil recovery operations or it is simply fed to a storage unit. The components of the system are fluidly connected by the appropriate piping.

The invention utilizes equipment in part that can be used for more than one type of liquid cryogen and vaporized form thereof without having to have its settings changed at all or substantially at all in the event that a different liquid cryogen is used. So for example, an operator might desire that carbon dioxide be employed in an enhanced oil recovery operation first and followed up by the addition of nitrogen after a period of time. The present invention can provide both without the operator of the gas provisioning system making any or any substantial changes to the settings of the vaporizer and coolant exchanger.

In one embodiment of the invention, there is disclosed a method for producing a gas for use in an enhanced oil recovery operation comprising the steps:
a) Feeding a liquid cryogen to a pump;
b) Feeding the liquid cryogen from the pump to a vaporizer whereby the liquid cryogen vaporizes to form a gas and wherein said vaporizer is capable of vaporizing a different liquid cryogen without any or any substantial adjustment to its settings;
c) Feeding the gas to a coolant exchanger, wherein said coolant exchanger is capable of cooling a different gas without any or any substantial adjustment to its settings; and
d) Feeding the gas to the enhanced oil recovery operation.

The liquid cryogen that may be vaporized is selected from the group consisting of nitrogen and carbon dioxide and may also consist of a mixture of nitrogen and carbon dioxide.

The pump is typically a high pressure pump that is capable of pressurizing the liquid cryogen to a pressure of about 100 to 500 psia. The pump may be assisted by a booster between the source of the liquid cryogen and the pump.

The liquid cryogen is fed to a vaporizer where the pressure is increased to 1400 to 5000 psia and the liquid cryogen becomes a gas.

The vaporizer directs the gas to a coolant exchanger where the high pressure gas is fed to an operation such as enhanced oil recovery operations or to storage for other uses onsite. The coolant exchanger is in a thermal exchange relationship with a combustion engine which is powered by a hydrocarbon such as diesel fuel or natural gas. The combustion engine will provide hot engine coolant to the coolant exchanger while the coolant exchanger provides cooled engine coolant to the combustion engine therefore allowing for efficient operation of the combustion engine.

The combustion engine is used to provide power to a hydraulic pump which will draw fluid from a hydraulic fluid reservoir and direct it to hydraulic drivers. The hydraulic drivers convert pressure energy from the hydraulic fluid into mechanical energy. This mechanical energy is transmitted to the booster pump, the high pressure pump and the vaporizer fan.

In an alternative embodiment of the invention, there is disclosed a method for providing high pressure gas to an enhanced oil recovery operation comprising the steps:
a) Feeding liquid cryogen to a pump;
b) Feeding the liquid cryogen from the pump to a vaporizer whereby the liquid cryogen vaporizes to form a gas and wherein said vaporizer is capable of vaporizing a different liquid cryogen without any or any substantial adjustment to its settings;
c) Feeding the gas to a coolant exchanger, wherein said coolant exchanger is capable of cooling a different gas without any or any substantial adjustment to its settings; and
d) Feeding the gas to the enhanced oil recovery operation.

For purposes of the present invention, the phrase “wherein said vaporizer is capable of vaporizing a different liquid cryogen without any or any substantial adjustment to its settings” means that the vaporizer that is used to vaporize a liquid cryogen to gas can be used to vaporize a second, different liquid cryogen to gas without any or any substantial changes made to its settings under which it vaporizes a liquid cryogen.

For purposes of the present invention, the phrase “wherein said coolant exchanger is capable of cooling a different liquid cryogen without any or any substantial adjustment to its settings” means that the coolant exchanger that is used to cool a gas can be used to cool a second, different gas without any or any substantial changes made to its settings under which it cools a gas.

### BRIEF DESCRIPTION OF THE DRAWINGS

FIG. 1 is a schematic of the system configured for providing high pressure nitrogen gas per the invention.

FIG. 2 is a schematic of the system configured for providing supercritical carbon dioxide per the invention.

### DETAILED DESCRIPTION OF THE INVENTION

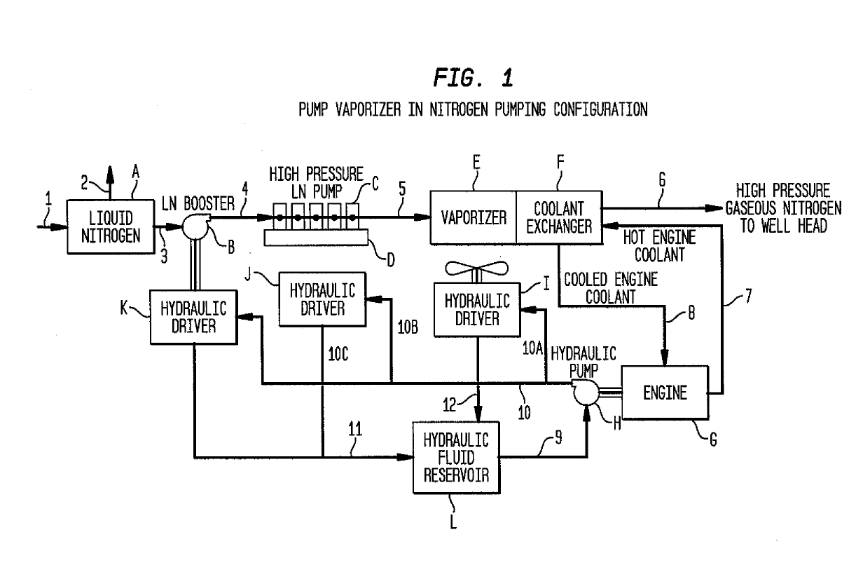

Turning to FIG. 1, a schematic of the invention is shown for pressurizing and vaporizing liquid nitrogen for use in enhanced oil recovery operations. The liquid nitrogen is fed through line 1 to a liquid storage tank A. The storage tank A can be capable of storing either the liquid nitrogen or liquid carbon dioxide which are typically stored at two different temperatures: liquid nitrogen in the range of 320 to −270° F. (−196 to −168° C.) and liquid carbon dioxide in the range of −85 to −45° F. (−65 to −43° C.). Depending on the application, storage tank A consists of a single tank or a series of separate tanks that are manifolded together to form a common liquid nitrogen supply. The storage tank A is able to control pressure in the tank by venting through line 2 any gas present in the storage tank. A pressure building system is included to vaporize a portion of the liquid in order to maintain pressure during operations. The storage tank A can be any storage tank that is used to store liquid cryogenic materials.

A booster pump B will receive a feed of the liquid nitrogen through line 3 from storage tank A. The liquid nitrogen will be fed at a pressure between 100 and 500 psia through line 4 into a high pressure reciprocating pump system C. This pump system is driven by a hydraulic driver D. This driver is common to both nitrogen and carbon dioxide pumping modes. The high pressure liquid nitrogen will be fed through line 5 at a pressure between 1400 and 5000 psia to a nitrogen air vaporizer E and nitrogen coolant exchanger F. The nitrogen air vaporizer E and coolant exchanger F will vaporize the liquid nitrogen and produce a gas in the pressure range of 1400 to 5000 psia and in the temperature range of 40 to 80° F. (4 to 27° C.), The resulting gaseous nitrogen is fed through line 6 directly to an enhanced oil recovery operation where it can be used in downhole operations. Alternatively, the gaseous nitrogen can be fed to a storage unit (not shown) for later use in the enhanced oil recovery operation.

The pumping and vaporization system is driven by a combustion engine G which can be either diesel or natural gas driven. An engine coolant is used to transfer heat through line 7 to the coolant exchanger F. Engine coolant from the coolant exchanger F is fed to the combustion engine G through line 8.

The pumps and vaporizer fans are driven by means of a hydraulic fluid in the following manner. A hydraulic fluid is fed through line 9 from the hydraulic fluid reservoir L to hydraulic pump H. Line 10 provides pressurized hydraulic fluid to hydraulic driver K and through lines 10A and 10B to hydraulic drivers I and J respectively. Low pressure hydraulic fluid is returned to the hydraulic fluid reservoir L through lines 10C, 11 and 12.

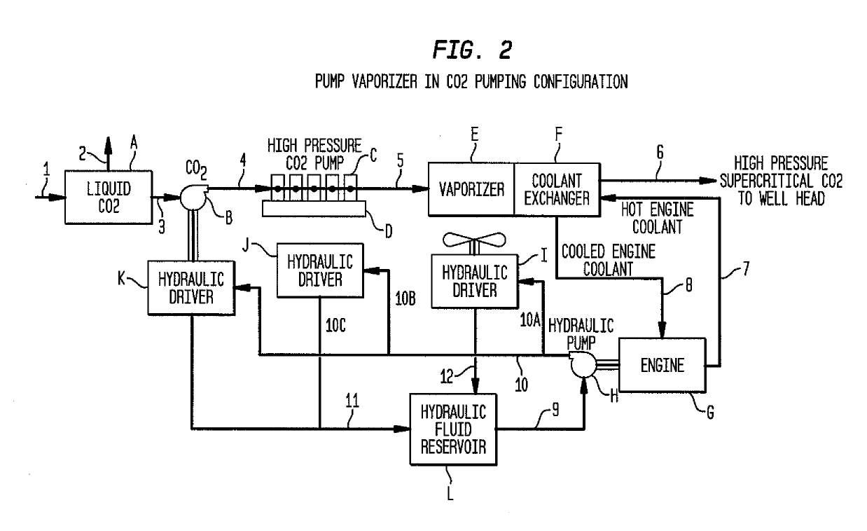

FIG. 2 provides a schematic of the invention is configured for pressurizing and vaporizing liquid carbon dioxide for use in enhanced oil recovery operations. The same number and letter designations are employed in FIG. 2 as are employed in FIG. 1 with the exception that carbon dioxide is being employed in the process of the invention in FIG. 2 while nitrogen is being employed in FIG. 1.

To service carbon dioxide, the booster pump B and the cold end cylinders C of the high pressure pump are replaced with materials compatible for pumping liquid carbon dioxide. The system operates in the same manner as the description for FIG. 1 to produce supercritical carbon dioxide in the pressure range of 1400 to 5000 psia and in the temperature range of 40 to 80° F. (4 to 27° C.).

While this invention has been described with respect to particular embodiments thereof, it is apparent that numerous other forms and modifications of the invention will be obvious to those skilled in the art. The appended claims in this invention generally should be construed to cover all such obvious forms and modifications which are within the true spirit and scope of the invention.

Having thus described the invention, what I claim is:

1. A method for producing a gas for use in an enhanced oil recovery operation comprising the steps:
a) Feeding a liquid cryogen to a pump;
b) Feeding said liquid cryogen from said pump to a vaporizer whereby said liquid cryogen vaporizes to form a gas and wherein said vaporizer is capable of vaporizing a different liquid cryogen without any or any substantial adjustment to its settings;
c) Feeding said gas to a coolant exchanger, wherein said coolant exchanger is capable of cooling a different gas without any or any substantial adjustment to its settings; and
d) Feeding said gas to said enhanced oil recovery operation.

2. The method as claimed in claim 1 wherein said liquid cryogen is selected from the group consisting of nitrogen, carbon dioxide and mixtures of nitrogen and carbon dioxide.

3. The method as claimed in claim 1 wherein said pump is a high pressure pump.

4. The method as claimed in claim 1 wherein said liquid cryogen is at a pressure of 100 to 500 psia.

5. The method as claimed in claim 1 wherein said liquid cryogen is vaporized to a pressure of 1400 to 5000 psia.

6. The method as claimed in claim 1 further comprising feeding said liquid cryogen to a booster prior to feeding to said pump.

7. The method as claimed in claim 1 wherein said coolant exchanger is in a thermal exchange relationship with a combustion engine.

8. The method as claimed in claim 1 wherein said engine provides hot engine coolant to the coolant exchanger and the coolant exchanger provides cooled engine coolant to the combustion engine.

9. The method as claimed in claim 1 wherein said combustion engine provides power to a hydraulic pump.

10. The method as claimed in claim 1 wherein said hydraulic pump provides hydraulic fluid to a hydraulic driver connected to said pump.

11. A method for providing high pressure gas to an enhanced oil recovery operation comprising the steps:
a) Feeding liquid cryogen to a pump;
b) Feeding said liquid cryogen from said pump to a vaporizer whereby said liquid cryogen vaporizes to form a gas and wherein said vaporizer is capable of vaporizing a different liquid cryogen without any or any substantial adjustment to its settings;
c) Feeding said gas to a coolant exchanger, wherein said coolant exchanger is capable of cooling a different gas without any or any substantial adjustment to its settings; and
d) Feeding said gas to said enhanced oil recovery operation.

12. The method as claimed in claim 11 wherein said liquid cryogen is selected from the group consisting of nitrogen, carbon dioxide and mixtures of nitrogen and carbon dioxide.

13. The method as claimed in claim 11 wherein said pump is a high pressure pump.

14. The method as claimed in claim 11 wherein said liquid cryogen is at a pressure of 100 to 500 psia.

15. The method as claimed in claim 11 wherein said liquid cryogen is vaporized to a pressure of 1400 to 5000 psia.

16. The method as claimed in claim 11 further comprising feeding said liquid cryogen to a booster prior to feeding to said pump.

17. The method as claimed in claim 11 wherein said coolant exchanger is in a thermal exchange relationship with a combustion engine.

18. The method as claimed in claim 11 wherein said engine provides hot engine coolant to the coolant exchanger and the coolant exchanger provides cooled engine coolant to the combustion engine.

19. The method as claimed in claim 11 wherein said combustion engine provides power to a hydraulic pump.

20. The method as claimed in claim 11 wherein said hydraulic pump provides hydraulic fluid to a hydraulic driver connected to said pump.
